(19) United States
(12) Patent Application Publication
(10) Pub. No.: US 2012/0132579 A1
(43) Pub. Date: May 31, 2012

(54) MEMBRANE FILTER ASSEMBLY AND PERMEATE CONNECTOR

(76) Inventors: Jeffrey Ronald Cumin, Hamilton (CA); Reid Allyn Bayly, East York (CA)

(21) Appl. No.: 12/956,301

(22) Filed: Nov. 30, 2010

(51) Int. Cl. B01D 63/00; F16L 21/00

(52) U.S. Cl. 210/321.72; 285/237

(57) ABSTRACT

The permeate collectors of a set of membrane filter elements are connected in line to form a vertical permeate collection pipe serving the set of elements. The connectors between adjacent elements are configured to allow a disconnected element to move perpendicular to the permeate collectors. When an element is disconnected, it may slide horizontally out of the frame. A connector has a spigot that spans between two sockets when connected. In a membrane assembly, each socket is associated with a permeate collector of a membrane filter element. To disconnect the sockets, the spigot is retracted further into one of the sockets until it is spaced apart from the other socket. With the spigot retracted, one membrane element may move relative to the other in a direction perpendicular to the direction of movement of the spigot.

### FIELD

This specification relates to assemblies of filtering membrane elements and to a permeate connector for membrane elements.

### BACKGROUND

The following is not an admission that anything discussed below is citable as prior art or common general knowledge.

In a membrane assembly described in European Patent EP1146954 B1, several membrane elements are assembled together into a cassette. Each element has a bundle of hollow fiber membranes extending horizontally between two vertically oriented potting heads. The ends of the membranes are open to a permeate collector on the back of one of the potting heads. A spigot on the back of the permeate collector functions as a permeate withdrawal port. To form a cassette, a frame is assembled providing an orthogonal grid of spaces. For example, the frame may provide two or three rows and several columns of spaces. Each space is configured to receive, or release, an element by sliding the element horizontally into or out of the space. A system of permeate collection pipes are provided behind the frame. As an element is slid into a space in the frame, the spigot on the back of the element slides into a socket connected to the permeate pipe system. In this way, a large filtration cassette can be assembled for immersion into a tank of water to be treated, but individual elements can be removed from the cassette for maintenance or replacement without disassembling the rest of the cassette.

### INTRODUCTION

The following introduction is intended to introduce the reader to the more detailed description to follow and not to limit or define any claimed invention.

The inventors have noticed that one disadvantage with the system shown in EP 1146954 B1 is that the permeate pipe system behind the cassette frame increases the footprint, or plan view area, of the cassette. This interferes with optimizing the use of space within a tank, and in particular interferes with maximizing the membrane tank intensity, or membrane surface area per unit of footprint. Further, the flow path for permeate involves two turns, from the permeate collector of the element to the spigot and from the spigot to the permeate collection system. Particularly when coupled with a small diameter spigot, this can cause a material resistance to permeate flow. The permeate pipe system can also sometimes involve a large number of components and fabrication steps. It can also be difficult to inspect the permeate connections in some cases because the connections are made at the back of the frame.

In a membrane assembly described herein, the permeate collectors of a set of elements are connected in line to form a permeate collection pipe serving the set of elements. For example, for elements in a vertical column in a frame, the top of the permeate collector of a lower element is connected to the bottom of the permeate collector of an upper element. The top of the permeate collector of the upper most element may discharge permeate upwards to a permeate collection system located above the elements. In this way, a permeate collection system behind the frame is avoided and the tank intensity of the cassette is increased. Further, the parts count of the assembly is reduced and turns in the permeate flow path to and from the spigot are avoided.

The connectors between adjacent elements may be configured to allow a disconnected element to move perpendicular to its permeate collector. The connectors may have a cross sectional area (measured perpendicular to the direction of permeate flow) similar to that of the permeate collector, to reduce resistance to permeate flow and provide access to the membrane ends if required to seal the end of a broken membrane.

In a connector described herein, there is spigot movable along a line between two sockets. When two elements are connected together, the spigot spans between the two sockets. To disconnect an element, the spigot is retracted into the socket of one of the elements and out of the socket of the disconnected element. A means for moving the spigot may be provided. For example, the spigot may be moved by way of a nut located between the sockets. The nut engages a threaded portion of the spigot. The spigot is not permitted to rotate and so rotating the nut causes the spigot to translate. A sliding seal is provided between the spigot and each socket, for example by way of one or more O-rings or other gaskets on the spigot or sockets. Each of the sockets may be associated with the permeate collector of each of two membrane elements. When disconnected, one membrane element may move relative to another in a direction perpendicular to the movement of the spigot.

### FIGURES

FIG. 1 shows a cross section of a connector.

FIG. 2 shows an assembly of filtering membrane elements.

FIG. 3 shows an exploded end view of an assembly of two filtering membrane elements and a connector.

FIG. 4 shows an isometric cut away view of the assembly of FIG. 3 cut along section D-D of FIG. 3.

FIG. 5 is an enlargement of area E of FIG. 4.

### DETAILED DESCRIPTION

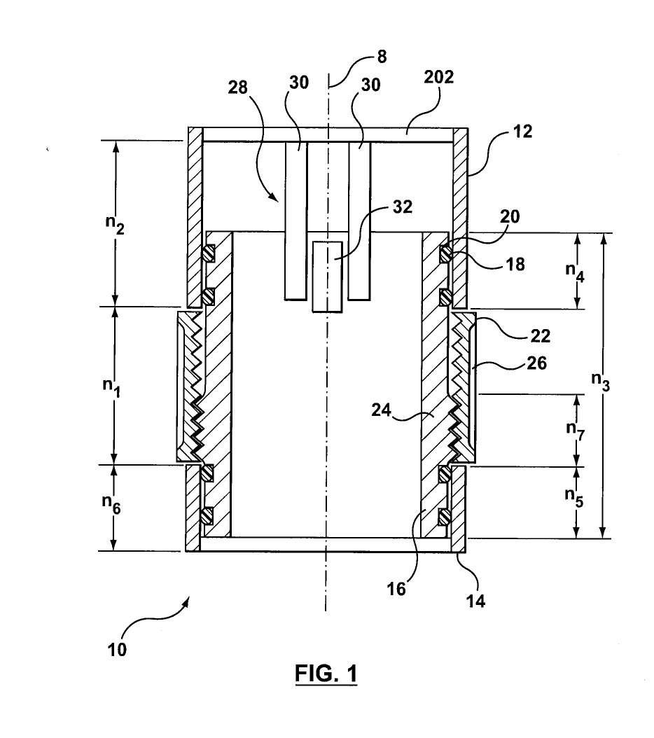

FIG. 1 shows a connector 10. The connector 10 has a first socket 12, a second socket 14 and a spigot 16. The sockets 12, 14 and the spigot 16 are generally cylindrical. When the connector 10 is in a connected position as shown, the centers of the sockets 12, 14 and the center of the spigot are in line with each other along a central axis 8. One end of the spigot 16 is associated with each of the sockets 12, 14. The outside diameter of each end of the spigot 16 is less than the inside diameter of its associated socket 12, 14 such that each end of the spigot 16 can slide in its associated socket 12, 14. Optionally, the sockets 12, 14 may have the same inside diameter. Seals are made between the spigot 16 and the sockets 12, 14 by way of O-rings 18 located in grooves 20 in the spigot 16. Alternatively, sealing rings may be located in groves in the sockets 12, 14.

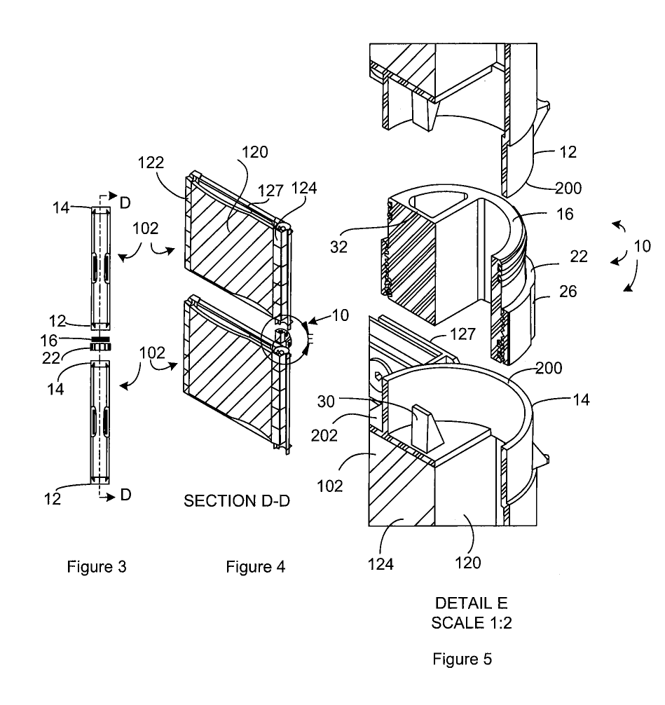

A nut 22 is located between the sockets 12, 14. Threads on the inside of the nut 22 engage with a threaded section 24 of the spigot 16. Indents 26 may be provided on the outside of the nut 22 to assist in turning the nut 22 by hand. The inside diameter of the nut 22 is greater that the outside diameters of the O-rings 18. A rotational stop 28 prevents the spigot 16 from turning when the nut 22 is turned but allows the spigot 16 to slide relative to the first socket 12. Accordingly, turning the nut 22 causes the spigot to translate along the central axis 8, moving into or out of the second socket 14. The rotational stop 28 shown has a pair of pins 30 or abutments located on either side of block 32 connected to the spigot 16. In the connector 10 shown, the pins 30 are connected to the first socket 12 by a plate 202 shown more clearly in FIG. 3. Other rotational stops could also be used, for example a single pin 30 connected to the first socket 12 and passing through a hole in a plate connected to the spigot 16, or an inverted structure wherein one or more pins 30 or abutments are attached to the spigot 16.

FIG. 1 shows the connector 10 with the spigot 16 in a connected position. The connector 10 can be moved to a retracted, or unconnected, position by rotating nut 22. This causes the threaded section 24 of spigot 16 to move inside the nut 22 away from the second socket 14 until the spigot 16 is fully removed from the second socket 16. With the connector 10 in a retracted position, the sockets 12 can move relative to each other in a direction perpendicular to the central axes 8.

The openings of the sockets 12, 14 face each other but are spaced apart by a distance n1. The first socket 12 has a depth of n2 and the second socket 14 has a depth of n6. The spigot 16 has an overall length of n3 and lengths n4 and n5 of first and second socket 12, 14 engagement sections. The threaded portion 24 of spigot 16 has a nominal length of n7, which is not necessarily all threaded but extends from the second socket engagement area n5 to the distal ends of the threaded portion 24. The sum of the depth n2 of the first socket 12 and the spacing distance n1 is greater than the overall length n3 of the spigot 16. The depth n2 of the first socket 12 is greater than the sum of the socket engagement lengths of n4 and n5 of the spigot 16. The spacing distance n1 is greater than the sum of the second socket engagement length n5 and the length n7 of the threaded portion 24 of the spigot 16.

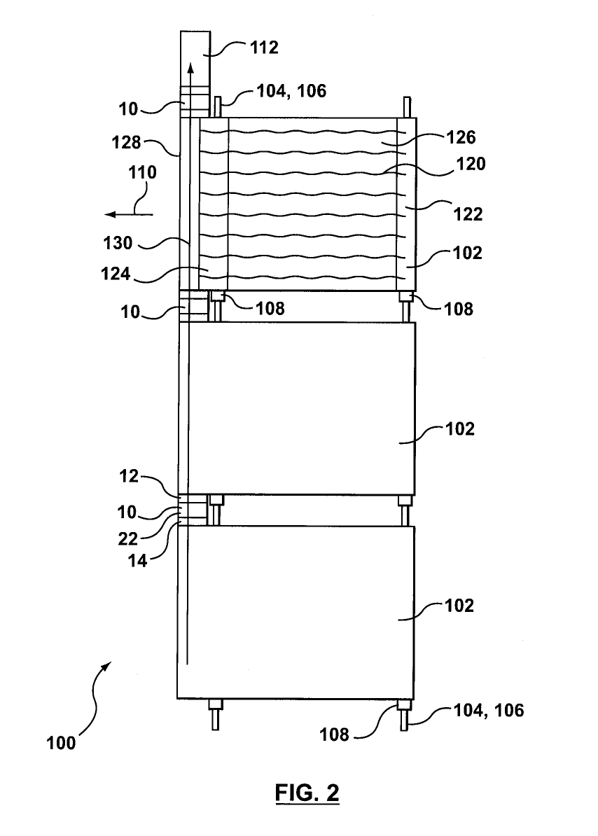

FIG. 2 shows a side view of a membrane cassette 100. The membrane assembly 100 has a stack of membrane filter elements 102. A plurality of such stacks may be placed side by side and held in a frame 104. The frame 104 has vertical posts 106 on both sides of the stack (the posts 106 on only one side of the stack are shown in FIG. 2), which support horizontal beams 108, which in turn support the filter elements 102. Other frame designs may also be used. However, the frame 104 preferably allows a selected element 102 to be removed from the frame 104 without requiring disassembly of the frame 104 or removal of other elements 102. In the frame 104 shown, an element 102 may be removed by pulling it in the removal direction 110 shown and replaced by moving it in the reverse direction.

Connectors 10 between the elements 102 are as shown in FIG. 1. Optionally, a connector 10 may also be used between the top of an upper element 102 and a permeate collector pipe 112 over the cassette 100. The sockets 12, 14 of the connectors 10 are attached to the elements 102. Although the connectors 10 are shown attached to the outside of the elements 102, the sockets 12, 14 may also be attached to the elements 102 by being integrated into the elements 102. When the one or more connectors 10 connected to a selected element 102 are moved into their retracted positions, the selected element 102 is free to move in the removal direction 110 or in a reverse direction.

The elements 102 shown have hollow fiber membranes 120 extending horizontally between two potting heads, a static head 122 and a permeating head 124. Other membrane elements may be used. For example, a membrane element might have a second permeating head 124 in place of the static head 122, in which case connectors 10 could be used on both sides of the element. For further example, a membrane element might have flat sheet membranes.

The potting heads 122, 124 are held apart by a side plate 126 in the element 102 shown although rods or other structural members may also be used. The potting heads 122, 124 are essentially blocks of one or more potting materials, optionally held within a molded receptacle. The permeating head 124 is held within, or connected to, a permeate collector 128. Ends of the membranes 120 pass through the permeating head 124 and are open to the permeate collector 128. One or both ends of the permeate collector 128 are connected to one of the sockets 12, 14 of a connector 10. The permeate collectors 128 and connectors 10 together form a vertical conduit defining a flow path 130 for permeate to travel from the elements 102 to the permeate collector pipe 112.

Referring to FIG. 3, the upper end of a lower element 102 is shown with one end of a connector 10 integrated into the element 102. A plastic molding 200 is bonded to the end of permeating head 124 and permeate collector 128. The molding 200 provides a socket 12 or 14, a plate 202 and an abutment 30 extending from the plate. The other half of the molding 200 is a mirror image of the half shown. The lower end of an upper element 102 similarly has an inverted molding 200 bonded to it. A portion of the plate 202 outside of the socket 12, 14 is available to rest on a horizontal beam 108 of the frame 104. Although the same molding 200 may be used for both sides of a connector 10, the molding for one side of the connector 10 may alternatively have a height just greater than n5. A socket 16 and nut 22 as shown in FIG. 1 may be placed between the moldings 200 to complete the connector. Ends of the membranes 120 thereby discharge permeate into a conduit formed by the semi-cylindrical space between the permeating head 124 and the permeate collector 128, and the inner surfaces of the connector 10. The sockets 12, 14 have a diameter that is generally similar to, for example at least 80% or 90% of, the width of the permeating head 124, which provides access to the open ends of the membranes 120 for maintenance such as pinning or otherwise closing the end of a broken membrane.

The connectors and membrane assemblies described above are merely examples. Various other membrane assemblies or connectors can also be made according to the invention, which is defined by the following claims.

1. An assembly of membrane filter elements comprising,
a) a first membrane filter having a first permeate collector;
b) a second membrane filter having a second permeate collector;
c) a first socket attached to or integral with the first permeate collector;
d) a second socket attached to or integral with the second permeate collector, the second socket being spaced apart from the first socket;
e) a spigot, the spigot having a first end associated with the first socket and a second end associated with the second socket;
f) a first seal attached to the first socket or the first end of the spigot, and a second seal attached to the second socket or the second end of the spigot;
wherein,
g) in a connected position, the first socket overlaps with the first end of the spigot and the first seal is located between them, and the second socket overlaps with the second end of the spigot and the second seal is located between them;
h) in a retracted position, the first socket overlaps with the first end of the spigot and the first seal is located between them, and the second end of the spigot is spaced apart from the second socket; and,
i) the spigot is movable between the connected and retracted positions.

2. The assembly of claim 1 comprising a first threaded section on the spigot and a corresponding second threaded section that is positioned relative to the first socket.

3. The assembly of claim 2 wherein the second threaded section is provided on a rotatable nut threaded on to the spigot and located between the first socket and the second socket and the assembly comprises a stop that generally prevents rotation of the spigot.

4. The assembly of claim 1 wherein each of the membrane filter elements has a first socket and a second socket.

5. The assembly of claim 4 wherein for each of the membrane filter elements, the first socket and second socket are located at opposite ends of the membrane filter element.

6. The assembly of claim 5 wherein the first socket and the second socket are mirror images of each other, whereby a membrane filter element may be connected to the other in an inverted orientation.

7. The assembly of claim 1 wherein each of the membrane filter elements is held in a frame and the membrane filter elements can be removed from the frame in a direction perpendicular to the length of the spigot.

9. The assembly of claim 1 wherein the sockets are generally cylindrical and a diameter that is generally equal to the width of the potting heads of the membrane filter elements.

10. A coupling comprising,
a) a first socket attached to a first membrane filter element;
b) a second socket attached to a second membrane filter element;
c) a spigot having a threaded section between two ends, each end associated with one of the sockets;
d) a nut located between the sockets and threaded on to the threaded section of the spig;
e) a rotational stop configured to prevent the spigot from rotating relative to the sockets; and,
f) a sliding seal between each end of the spigot and its associated socket; wherein,
g) rotating the nut causes the spigot to move between a connected position and a retracted position;
h) in the connected position, the sliding seal at each end of the spigot is engaged with its associated socket; and,
i) in the retracted position, the sliding seal of one end of the spigot is outside of its associated socket.

11. The assembly of claim 10 wherein the sliding seals comprise one or more O-rings provided in grooves in the ends of the spigot.

12. The assembly of claim 10 wherein the inside diameter of the nut is greater than the inside diameters of the sockets.

13. The assembly of claim 10 wherein the sockets are attached to or integrated into the permeate cavities of membrane filters.

14. The assembly of claim 10 wherein both of the sockets are made from a common molding.

15. A membrane assembly comprising,
a) a set of membrane elements, each membrane element having a vertical permeate conduit, wherein the membrane elements are arranged in a stack with their permeate conduits aligned in a vertical column;
b) connectors between the permeate conduits of adjacent membrane elements;
wherein the connectors are releasable and, when released, allow movements of a released element perpendicular to the permeate conduits.

16. The assembly of claim 15 wherein the permeate conduits are formed by a permeating potting head and a permeate collector attached to the permeating potting head.

17. The assembly of claim 15 wherein the membrane elements are held in a frame and each element may be removed from the frame by sliding the element horizontally.
